(19) United States
(12) Patent Application Publication
(10) Pub. No.: US 2025/0012345 A1
(43) Pub. Date: Jan. 9, 2025

(54) Sliding Structure, Mounting Method and Actuator

(71) Applicant: CHANGZHOU KAIDI ELECTRICAL CO., LTD., Jiangsu (CN)

(72) Inventors: Xinran YAO, Jiangsu (CN); Gengxing ZHU, Jiangsu (CN); Zhenbin GONG, Jiangsu (CN)

(73) Assignee: CHANGZHOU KAIDI ELECTRICAL CO., LTD., Jiangsu (CN)

(21) Appl. No.: 18/708,277

(22) PCT Filed: Jun. 10, 2022
(86) PCT No.: PCT/CN2022/098156

§ 371 Date: May 8, 2024

(30) Foreign Application Priority Data
Nov. 16, 2021 (CN) 202111354229.1

(51) Int. Cl. F16H 25/20; F16C 29/02

(52) U.S. Cl. CPC F16H 25/20; F16C 29/02; F16H 2025/2031; F16H 2025/204

(57) ABSTRACT

A sliding structure includes a first pipe body; a second pipe body slidably provided inside the first pipe body; a first sliding part; and a second sliding part. Before assembly, the first sliding part is clamped on the second pipe body directly or indirectly through the second sliding part, with a part of the first sliding part extending beyond the second pipe body. When assembled, the first sliding part is detached from the second pipe body, wherein one side of the first sliding part is clamped on the inner wall of the first pipe body and the other side is slidable connected to the outer wall of the second pipe body. One side of the second sliding part is clamped on the outer wall of the second pipe body and the other side is slidable connected to the inner wall of the first pipe body.

### TECHNICAL FIELD

The present disclosure relates to the technical field of sliding structures, particularly to a sliding structure, a mounting method, and an actuator.

### BACKGROUND

Actuators are widely used in furniture or electrical appliances with adjustable positions, such as beds, chairs, and tables. The main function of actuators is to drive the target object to adjust its position, and its movement is intuitively represented as the linear reciprocating movement on the part of retractable pipe fittings. Sliding structures such as sliders, sliding blades, and sliding sleeves are usually disposed between the relatively moving pipe fittings to support components, reduce friction and eliminate clearance. In order to mount the sliding part on the inner wall or outer wall of the pipe fittings, a hole is usually processed on the side wall of the pipe fittings, and part of the sliding part is embedded in the hole.

For example, the Chinese patent with publication number CN104863937B discloses a casing assembly structure and a lifting column. The casing assembly includes two external casings that can be relatively retractable. A slider is disposed between the two casings, and a groove without penetrating the outer wall is disposed on the inner side wall of the outer pipe to avoid the presence of holes on the exposed pipe wall and affect aesthetics. However, in order to fit the corresponding slider into the groove on the inner wall of the outer pipe, the inner pipe is equipped with a hole groove structure to dodge the slider. These technological holes and grooves, which are made merely to facilitate the mounting, actually increase the processing cost, and to a certain extent, cause local stress changes, resulting in the deformation of pipe fittings, affecting the precision and smoothness of retractable movement of pipe fittings, and leading to the reduction of the rate of finished products. On the other hand, in order to facilitate mass production and reduce stress and deformation caused by processing, a preferred processing method is laser cutting, which is relatively efficient but expensive. At present, it is very difficult to mount the sliding part in the gap between two pipe fittings under the premise of avoiding too many holes in the pipe body.

### SUMMARY

The present disclosure aims at solving at least one of the technical problems existing in the prior art.

Accordingly, the present disclosure proposes a sliding structure, a mounting method, and an actuator, wherein the sliding structure has the advantages of removing the technological grooves which are disposed on the inner and outer pipe walls to assist mounting, firmly clamping the sliding part on the relatively retractable pipe fittings to prevent the sliding part from easily coming out or being pulled out, and at the same time improving the mounting speed and convenience.

The sliding structure according to some embodiments of the present disclosure contains a first pipe body; a second pipe body slidable disposed inside the first pipe body; a first sliding part; and a second sliding part. In some embodiments, one side of the second sliding part is clamped on the outer wall of the second pipe body, and the other side of the second sliding part is slidable connected to the inner wall of the first pipe body. In some embodiments, a part of the first sliding part extends beyond the end of the second pipe body when not mounted, and the first sliding part is directly clamped on the second pipe body or indirectly clamped on the second pipe body by the second sliding part. In some embodiments, when mounted, the first sliding part is detached from the end of the second pipe body, one side of the first sliding part is clamped on the inner wall of the first pipe body, and the other side of the first sliding part is slidable connected to the outer wall of the second pipe body.

The present disclosure has the beneficial effects that the pocket holes required for mounting the first sliding part are reduced in quantity, which reduces the production cost, improves the service strength of the pipe wall, and avoid the deformation of the pipe wall. In addition, by directly or indirectly clamping the first sliding part on the second pipe body, part of the first sliding part extends beyond the end of the second pipe body and no additional positioning tool is required to fix the first sliding part, thus reducing the cost and improving the assembly efficiency.

In some embodiments, the first sliding part includes a connecting part, which is disposed between the second pipe body and the first pipe body; a flange edge, which is disposed at one end of the connecting part, and abuts against the end face of the first pipe body; and a plurality of first sliders, which are arranged between the second pipe body and the first pipe body and are connected to the other end of the connecting part.

In some embodiments, one end of the outer wall of the second pipe body is equipped with a plurality of second slotted holes, and the second sliding part contains a second boss which is clamped in the second slotted holes. In some embodiments, the second sliding part further include a second slider, which is connected to the second boss and is slidable connected to the first pipe body.

In some embodiments, when not mounted, the first slider is directly clamped on the second pipe body; the first sliding part is inclined towards the inner side of the second pipe body, and the first slider extends beyond the end of the second pipe body, so that the first sliding part is clamped on the end of the second pipe body.

In some embodiments, a clamping part is disposed between the first slider and the connecting part to face the second pipe body. When the first sliding part is not mounted, the clamping part is clamped against the end of the second pipe body.

In some embodiments, the clamping part is a transition surface, one end of which is connected to the first slider, and the other end of which is connected to the connecting part.

In some embodiments, when not mounted, the first sliding part is indirectly clamped on the second pipe body, the first sliding part is clamped with the second sliding part, and the first sliding part extends beyond the end of the second pipe body.

In some embodiments, the second sliding part is equipped with clamping teeth, the first sliding part is equipped with a bayonet matching the clamping teeth, and when the first slider is not mounted, the clamping teeth are clamped with the bayonet.

In some embodiments, the bayonet includes a stop wall and an escape wall, which are connected to each other, the stop wall is located at the side of the bayonet close to the flange edge, an acute angle is formed between the stop wall and the escape wall, and the clamping teeth are rod-shaped protrusion inclined towards the bayonet. When the first sliding part is not mounted, the bottom surface of the rod-shaped projection abuts against the stop wall, and the side surface of the rod-shaped projection abuts against the escape wall.

In some embodiments, a sliding gap exists between the second pipe body and the first pipe body, the thickness of the connecting part is less than the width of the sliding gap, and the thickness of the first sliding part is more than or equal to the width of the sliding gap.

In some embodiments, a sliding gap exists between the second pipe body and the first pipe body, interference fit is realized between the first slider and the sliding gap, and clearance fit is realized between the connecting part and the second pipe body.

In some embodiments, a first boss is disposed on the side of the first slider facing the first pipe body, and a plurality of first slotted holes for accommodating the first bosses are disposed on the end of the inner wall of the first pipe body.

In some embodiments, when the first sliding part is not mounted, a gap exists between the first boss and the inner wall opposite the first pipe body.

In some embodiments, the first slotted hole does not penetrate the inner wall of the first pipe body.

In some embodiments, the side of the first slotted hole far away from the flange edge forms a chamfered surface, and the side of the first slotted hole close to the flange edge abuts against the first boss.

In some embodiments, the side of the first boss far away from the flange edge has a guide slope, and the guide slope is used for guiding the first pipe body when the first sliding part is not mounted.

In some embodiments, a plurality of the first sliders is arranged along the circumferential direction of the second pipe body.

In some embodiments, a plurality of the second sliders is arranged along the circumferential direction of the second pipe body.

In some embodiments, the first sliding part is an annular structure, an unclosed C-shaped annular structure, or is formed by splicing two opposite half rings.

The present disclosure further describes a mounting method of the above-mentioned sliding structures. In some embodiments, a mounting method according to the above sliding structure includes the following steps: step 1, vertically place a second pipe body on an operating platform, so that the end of the second pipe body equipped with a second slotted hole faces upwards; step 2, apply the first sliding part on the second pipe body from top to bottom, so that the clamping part abuts against the upper end of the second pipe body, and meanwhile the first sliding part is inclined towards the inside of the second pipe body, so that the first sliding part is clamped on the end of the second pipe body; step 3, place the second sliding part inside the second slotted hole; and step 4: apply the first pipe body on the outer surface of the first slider from top to bottom, and the lower end of the first pipe body abuts against the flange edge during the downward movement of the first pipe body and drives the first sliding part to move downwards, so that the first sliding part enters the gap between the first pipe body and the second pipe body, and meanwhile the first boss snaps into the first slotted hole.

In some embodiments, a mounting method of the sliding structure contains the following steps: step 1, apply the first sliding part on the second pipe body, and fix the second sliding part on the second pipe body; step 2, move the first sliding part until the first sliding part is engaged with the second sliding part, so that the first sliding part is fixed on the second pipe body; step 3, apply the first pipe body on the outer surface of the first sliding part, and the first pipe body presses the first sliding part to bend and deform towards the inside of the second pipe body, so that the first pipe body can be applied on the first sliding part conveniently; step 4: push the first pipe body to the second pipe body. When the end of the first pipe body abuts against the flange edge, one side of the first sliding part is clamped on the inner wall of the first pipe body. Then, the first pipe body drives the first sliding to depart from the second sliding part, so that the first sliding part and the second sliding part detach from each other.

The present disclosure further describes an actuator including the above-mentioned sliding structures. In some embodiments, an actuator includes a sliding structure as described above; a box body, where a driving part is disposed inside and which is fixedly connected to one end of the sliding structure; a screw rod assembly, arranged in the sliding structure and containing a hollow transmission rod, a screw rod and a nut. In some embodiments, one end of the hollow transmission rod is connected to the rotating end of the driving part; the other end of the hollow transmission rod is fixedly connected to a nut; the screw rod is disposed inside the hollow transmission rod; the outer peripheral surface of the screw rod is engaged with the nut through threads; the end of the screw rod far from the box body is connected to the other end of the sliding structure; and the driving part drives the sliding structure to do retractable motion by the screw rod assembly.

In some embodiments, the end of the screw rod far away from the box body is directly connected to a bottom plate, the outer peripheral surface of the bottom plate is fixedly connected to the inner wall of the second pipe body, and the box body is fixedly connected to the first pipe body.

In some embodiments, the end of the screw rod far away from the box body is directly connected to a bottom plate, the outer peripheral surface of the bottom plate is fixedly connected to the inner wall of the first pipe body, and the box body is fixedly connected to the second pipe body.

In some embodiments, the sliding structure further contains a third pipe body which is slidable applied outside the first pipe body, and the structure between the third pipe body and the first pipe body is the same as that between the first pipe body and the second pipe body. Other features and advantages of the present disclosure will be set forth in the specification that follows, and in part will be obvious from the specification, or may be learned by practice of the present disclosure. The objects and other advantages of the present disclosure are realized and obtained by the structure particularly pointed out in the specification, claims, and drawings.

In order to make the above objects, features, and advantages of the present disclosure more obvious and understandable, the following preferred embodiments will be described in detail with reference to the attached drawings.

### BRIEF DESCRIPTION OF THE DRAWINGS

The above and/or additional aspects and advantages of the present disclosure will become apparent and easy to understand from the description of embodiments in the following drawings, in which:

FIG. 1 is a cross-sectional schematic diagram of an actuator according to some embodiments of the present disclosure;

FIG. 2 is an exploded schematic diagram of an actuator according to some embodiments of the present disclosure:

FIG. 3 is a mounting schematic diagram of a sliding structure according to Embodiment 1 of the present disclosure:

FIG. 4 is a mounting schematic diagram of a sliding structure according to Embodiment 1 of the present disclosure:

FIG. 5 is an enlarged schematic diagram of Area E in FIG. 4:

FIG. 6 is a mounting schematic diagram of a sliding structure according to Embodiment 1 of the present disclosure:

FIG. 7 is an enlarged schematic diagram of Area F in FIG. 6;

FIG. 8 is a structural schematic diagram of a first sliding part in a sliding structure according to Embodiment 1 of the present disclosure:

FIG. 9 is a structural schematic diagram of a second sliding part in a sliding structure according to Embodiment 1 of the present disclosure:

FIG. 10 is a structural schematic diagram of a second sliding part according to Embodiment 2 of the present disclosure:

FIG. 11 is a structural schematic diagram of a first sliding part according to Embodiment 2 of the present disclosure;

FIG. 12 is a schematic diagram of a sliding structure during mounting according to Embodiment 2 of the present disclosure:

FIG. 13 is an enlarged schematic diagram of Area B in FIG. 12;

FIG. 14 is a schematic diagram of a sliding structure during mounting according to some embodiments of the present disclosure:

FIG. 15 is an enlarged schematic diagram of Area C in FIG. 14;

FIG. 16 is a schematic diagram of a sliding structure during mounting according to Embodiment 2 of the present disclosure:

FIG. 17 is an enlarged schematic diagram of Area D in FIG. 16:

FIG. 18 is a structural schematic diagram of a first sliding part in a sliding structure according to some other embodiments of the present disclosure:

FIG. 19 is a structural schematic diagram of a first sliding part in a sliding structure according to some other embodiments of the present disclosure:

FIG. 20 is a cross-sectional schematic diagram of an actuator according to some other embodiments of the present disclosure:

FIG. 21 is a cross-sectional schematic diagram of an actuator according to some other embodiments of the present disclosure;

Reference Numerals: driving part 1, box body 2, screw rod assembly 3, second pipe body 4, first pipe body 5, first sliding part 6, second sliding part 7, second slotted hole 8, bottom plate 9, first slotted hole 10, chamfered surface 11, third pipe body 12, hollow transmission rod 31, screw rod 32, nut 33, flange edge 61, first slider 62, first boss 63, bayonet 64, clamping part 64a, connecting part 65, second slider 71, second boss 72, and clamping teeth 73.

### DETAILED DESCRIPTION

For the embodiments of the present disclosure described in detail below, examples are shown in the accompanying drawings, in which the same or similar reference numerals throughout refer to the same or similar elements or elements with the same or similar functions. The embodiments described below with reference to the accompanying drawings are exemplary, only for explaining the present disclosure, and should not be construed as limiting the present disclosure.

In the description of the present disclosure, it should be understood that, terms such as center, longitudinal, transverse, length, width, thickness, above, below; front, back, left, right, vertical, horizontal, top, bottom, inside, outside, clockwise, anticlockwise, axial, radial, and circumferential are only for the convenience of describing the present disclosure and simplifying the description, and it is not intended to indicate or imply that the referred devices or elements must have a specific orientation, or be constructed and operated in a specific orientation, therefore should not be construed as limiting the present disclosure. In addition, the features defined with “first” and “second” may include one or more of these features explicitly or implicitly. In the description of the present disclosure, “a plurality” means two or more, unless otherwise stated.

In the description of the present disclosure, it should be noted that unless otherwise specified and limited, the terms “mounted” and “connected” should be understood in a broad sense. For example, they can be fixedly connected, dismountable connected, or integrally connected: they can be mechanically connected or electrically connected: they can be directly connected or indirectly connected through an intermediate medium, or internally connected. For those skilled in the art, the specific meanings of the above terms in the present disclosure can be understood according to specific situations.

The sliding structure, the mounting method, and the actuator of the embodiment of the present disclosure are described in detail below with reference to the drawings.

### Embodiment 1

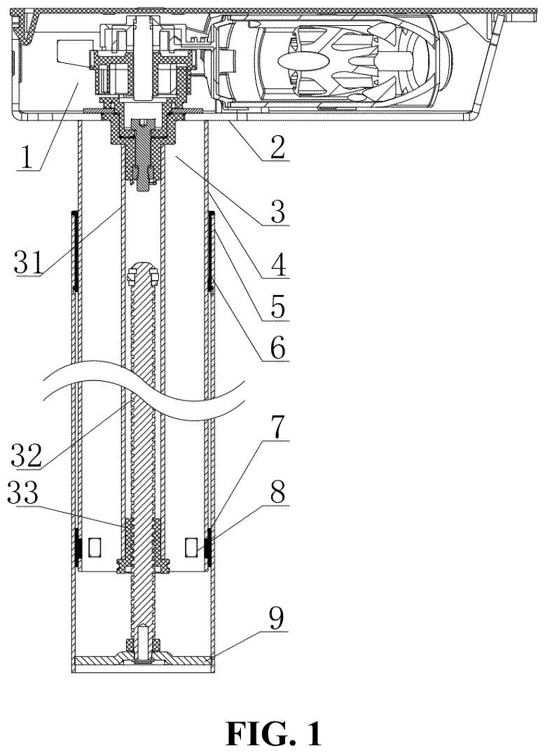

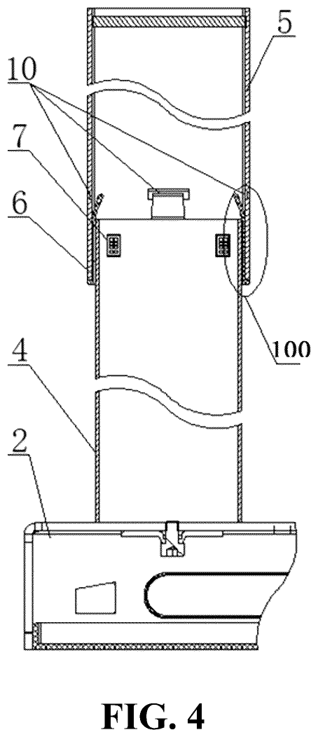

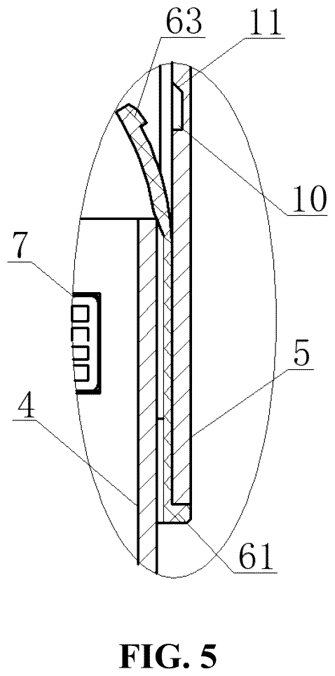

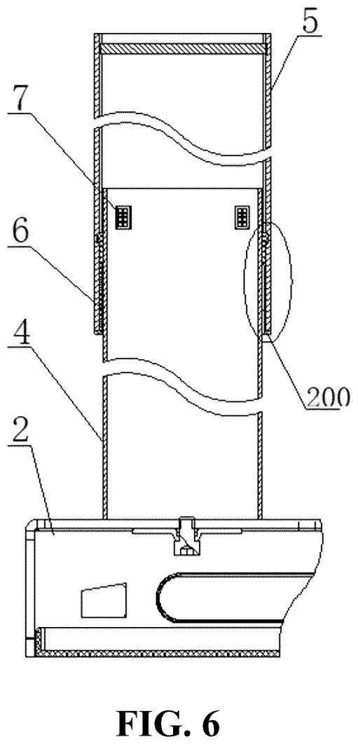

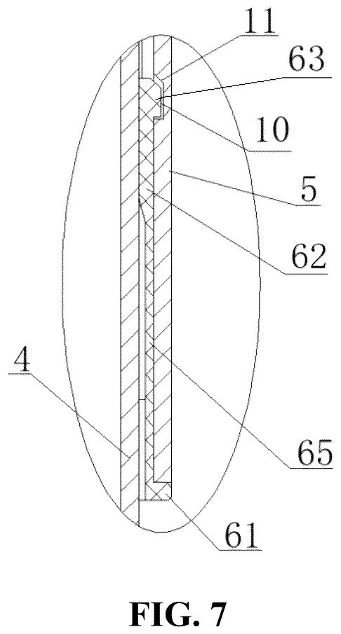

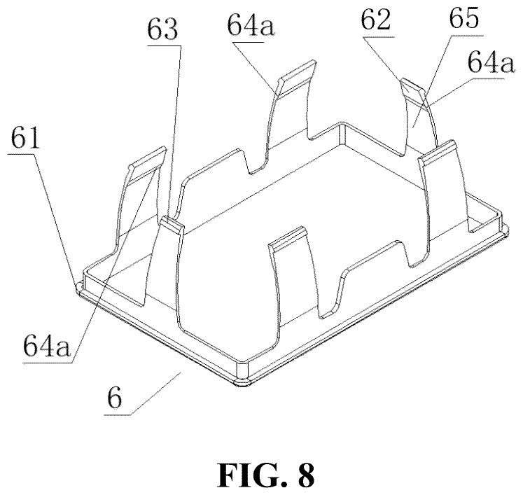

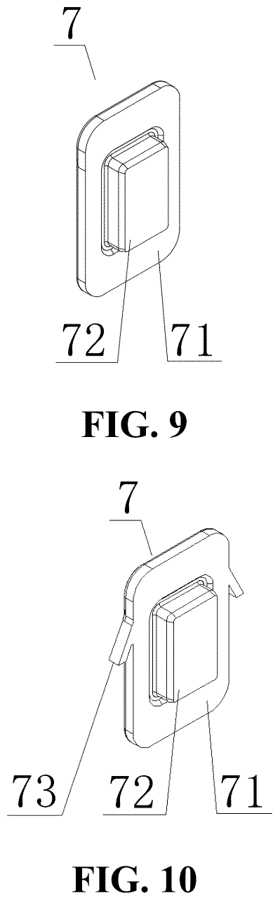

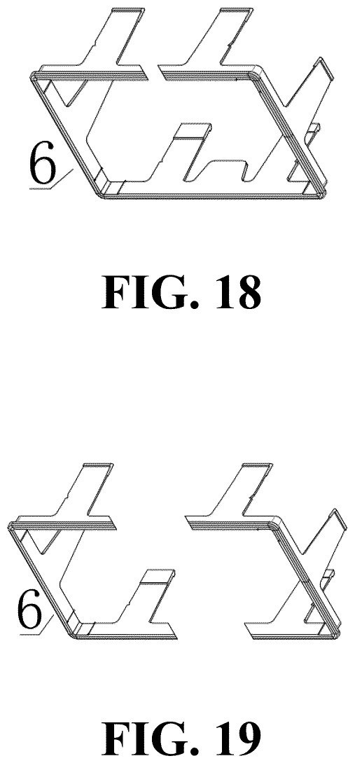

As shown in FIGS. 1 through 9, 18, and 19, the present disclosure discloses a sliding structure, which comprises a first pipe body 5, a second pipe body 4, a second sliding part 7 and a first sliding part 6, wherein the second pipe body 4 is slidably arranged in the first pipe body 5. In some embodiments, one side of the second sliding part 7 is clamped on the outer wall of the second pipe body 4, and the other side of the second sliding part 7 is slidably connected with the inner wall of the first pipe body 5. When the first sliding part 6 is not mounted, part of the first sliding part 6 extends beyond the end of the second pipe body 4, and the first sliding part 6 is directly clamped on the second pipe body 4. When the first sliding part 6 is mounted, the first sliding part 6 is detached from the end of the second pipe body 4. In some embodiments, one side of the first sliding part 6 is clamped on the inner wall of the first pipe body 5, and the other side of the first sliding part 6 is slidable connected with the outer wall of the second pipe body 4.

In other words, the first pipe body 5 is slidable applied on the second pipe body 4, and the first sliding part 6 and the second sliding part 7 are arranged between the first pipe body 5 and the second pipe body 4, so that the contact-free sliding between the first pipe body 5 and the second pipe body 4 can be achieved. The first sliding part 6 and the first pipe body 5 are relatively fixed, and the second sliding part 7 and the second pipe body 4 are relatively fixed. When the first pipe body 5 and the second pipe body 4 are extended, the distance between the first sliding part 6 and the second sliding part 7 becomes shorter. When the first pipe body 5 and the second pipe body 4 contract, the distance between the first sliding part 6 and the second sliding part 7 becomes longer. The cross sections of the first pipe body 5 and the second pipe body 4 are rectangular shapes, or other shapes, such as round, square, and oval shapes.

According to the present disclosure, the pocket holes required for mounting the first sliding part 6 are reduced in quantity: which reduces the production cost, improves the service strength of the pipe wall, and avoids the deformation of the pipe wall. When mounting the first sliding part 6, by directly clamping the first sliding part 6 on the second pipe body 4, part of the first sliding part 6 extends beyond the end of the second pipe body 4, and no additional positioning tool is needed to fix the first sliding part 6. At the same time, by using the space outside the end of the second pipe body 4, part of the first sliding part 6 is inclined inwards (it can be directly formed or inclined inward by external force), so that an outer circumference of the extending part of the first sliding part 6 is smaller than an inner circumference of the first pipe body 5, thus the first sliding part 6 can be smoothly mounted in the first pipe body 5, reducing the processing and assembly costs and improving the assembly efficiency.

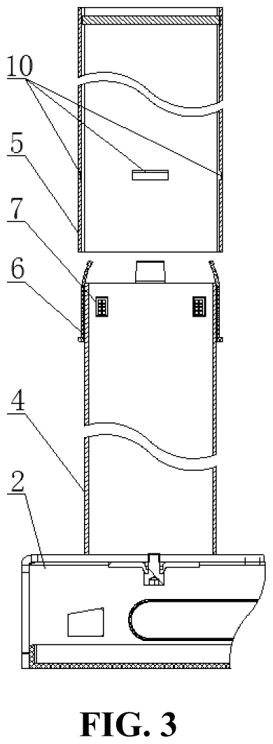

As shown in FIGS. 3 through 8, the first sliding part 6 includes a connecting part 65, a flange edge 61, and a plurality of first sliders 62. In some embodiments, the connecting part 65 is disposed between the second pipe body 4 and the first pipe body 5. The flange edge 61 is disposed at one end of the connecting part 65, and abuts against the end face of the first pipe body 5. A plurality of first sliders 62 are connected to the other end of the connecting part 65. That is, the flange edge 61 and the first slider 62 are connected by the connecting part 65, the first slider 62 is located between the second pipe body 4 and the first pipe body 5 for sliding guidance, the flange edge 61 is located at the end of the first pipe body 5, and the plane of the flange 61 is perpendicular to the axis of the first pipe body 5, which is convenient for the first pipe body 5 to push the flange 61, thus driving the move of the first sliding part 6.

In some embodiments, when the first sliding part 6 is directly clamped on the second pipe body 4, the first slider 62 is inclined towards the inside of the second pipe body 4, and the first slider 62 extends beyond the end of the second pipe body 4, so that the first sliding part 6 is clamped on the end of the second pipe body 4. In other words, when the first sliding part 6 is in a natural state, the first slider 62 is inclined inwards, and when the first slider 6 is mounted on the second pipe body 4, the connecting part 65 is applied on the second pipe body 4, and the inner circumference of the first slider 62 formed after the inclination is less than the outer circumference of the second pipe body 4, so that the first slider 62 extends beyond the end of the second pipe body 4, and then the first sliding part 6 is clamped on the end of the second pipe body 4.

In some embodiments, a clamping part 64a is disposed between the first slider 62 and the connecting part 65, and the clamping part 64a faces the second pipe body 4. When the first sliding part 6 is not mounted, the clamping part 64a abuts against the end of the second pipe body 4. In some embodiments, the clamping part 64a is a transition surface, one end of which is connected to the first slider 62, and the other end of which is connected to the connecting part 65. That is, the clamping part 64a can be any structure that can be clamped on the end of the second pipe body 4, preferably a transition surface, and the transition surface can be a curved surface or an inclined surface, thus facilitating the first slider 62 to enter the sliding gap.

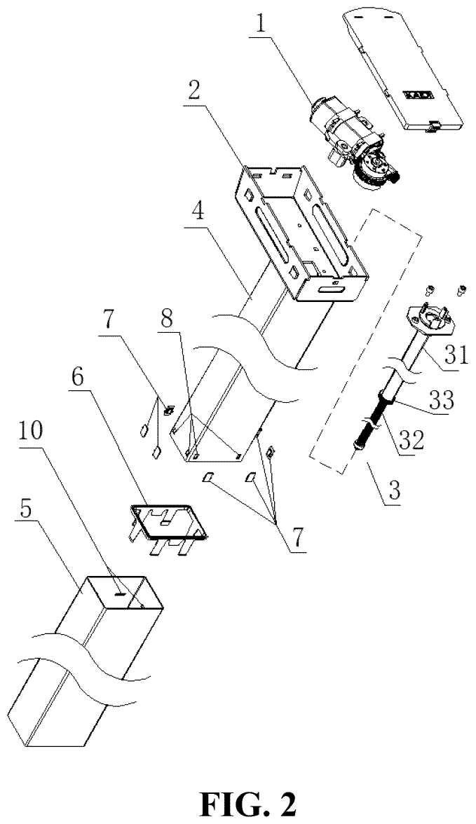

As shown in FIGS. 2 through 4, 6, and 9), one end of the outer wall of the second pipe body 4 is provided with a plurality of second slotted holes 8, the second sliding part 7 contains a second boss 72 and a second slider 71, and the second boss 72 is clamped in the second slotted holes 8. The second slider 71 is connected to the second boss 72, and the second slider 71 is slidable connected to the first pipe body 5. By the snap-fit between the second boss 72 and the second slotted hole 8, the second sliding part 7 can be conveniently mounted on the second pipe body 4.

In some embodiments, a plurality of first sliders 62 are arranged in the circumferential direction of the second pipe body 4, and a plurality of second sliders 71 are arranged in the circumferential direction of the second pipe body 4. That is, the first slider 62 and the second slider 71 are arranged around the second pipe body 4 at the same time to ensure that the gap between the second pipe body 4 and the first pipe body 5 in the circumferential direction is uniform during sliding, so that the sliding process is smoother.

According to an embodiment of the present disclosure, a sliding gap exists between the second pipe body 4 and the first pipe body 5, the thickness of the connecting part 65 is less than the sliding gap, and the thickness of the first slider 62 is more than or equal to the sliding gap. In some embodiments, interference fit is realized between the first slider 62 and the sliding gap, and clearance fit is realized between the connecting part 65 and the second pipe body 4. In other words, the second pipe body 4 and the first pipe body 5 are slidable connected by the first slider 62 and the second slider 71, and the thickness of the first slider 62 and that of the second slider 71 are more than or equal to the sliding gap between the second pipe body 4 and the first pipe body 5. In some embodiments, the thickness of the first slider 62 and the second slider 71 is slightly more than the sliding gap, so that interference fit can be realized between the first slider 62 and the second slider 71 with the sliding gap during sliding, thus the second pipe body 4 and the first pipe body 5 do not shake when sliding. The thickness of the connecting part 65 is less than the sliding gap, and a gap exists between the connecting part 65 and the second pipe body 4, so the connecting part 65 is thinner, and a movable space exists between the connecting part 65 and the second pipe body 4. On the one hand, it is convenient for the first sliding part 6 to be easily applied on the second pipe body 4. On the other hand, when the first sliding part 6 is mounted, the connecting part 65 can be deformed. Because of the small thickness of the connecting part 65 and the movable space between the first pipe body 5 and the second pipe body 4, the connecting part 65 is easily deformed inwards to dodge the first pipe body 5 during mounting, thus facilitating the first pipe body 5 to be applied on the second pipe body 4.

In some embodiments, the first slider 62 is equipped with a first boss 63 on the side facing the first pipe body 5, and one end of the inner wall of the first pipe body 5 is provided with a plurality of first slotted holes 10 for accommodating the first bosses 63. In some embodiments, the side of the first slotted hole 10 far away from the flange edge 61 forms a chamfered surface 11, and the side of the first slotted hole 10 close to the flange edge 61 abuts against the first boss 63. In other words, the flange edge 61 abuts against the first pipe body 5, thus forming the first limit point, and the first boss 63 is clamped in the first slotted hole 10, thus forming the second limit point. As the first sliding part 6 passes through the upper limit point and the lower limit point in the sliding gap, the first sliding part 6 is always fixed at the end of the first pipe body 5 during sliding, thus preventing the first sliding part 6 from naturally falling off or being pulled out from the second pipe body after working for a long time.

In some embodiments, when the first sliding part 6 is not mounted, a gap exists between the first boss 63 and the inner wall opposite the first pipe body 5. That is, when the first slider 62 is inclined towards the inside of the second pipe body 4, the first boss 63 is inclined towards the inside of the second pipe body 4, so that a certain distance exists between the inner wall of the first pipe body 5 and the first boss 63 during mounting, which makes it easier for the first pipe body 5 to be applied on the first sliding part 6.

According to one embodiment of the present disclosure, the first slotted hole 10 does not penetrate the inner wall of the first pipe body 5, and after the mounting, the exposed surface of the first pipe body 5 remains intact, which improves the aesthetic feeling of use.

According to one embodiment of the present disclosure, the first sliding part 6 is an annular structure, an unclosed C-shaped annular structure, or is formed by splicing two opposite half rings. The first sliding part 6 can be designed according to the actual needs, so as to improve the adaptability. It is suitable to use wear-resistant plastic to make the first sliding part 6 and the second sliding part 7, which can be directly injection molded.

According to one embodiment of the present disclosure, the side of the first slotted hole 10 far away from the flange edge 61 forms a chamfered surface 11, and the side of the first slotted hole 10 close to the flange edge 61 abuts against the first boss 63. In this way, even if the first slotted hole 10 extends widthwise to the area of the second sliding part 7, the chamfered surface 11 will not scratch the surface of the second slider 71 during assembly.

As shown in FIGS. 3 through 7, the present disclosure also provides a mounting method according to the sliding structure, which comprises the following steps: step 1, vertically place the second pipe body 4 on the operating platform, so that the end of the second pipe body 4 with the second slotted hole 8 faces upwards: step 2: apply the first sliding part 6 on the second pipe body 4 from top to bottom, so that the clamping part 64a abuts against the upper end of the second pipe body 4, and the first slider 62 is inclined towards the inside of the second pipe body 4, so that the first sliding part 6 is clamped on the end of the second pipe body 4: step 3, place the second sliding part 7 in the second slotted hole 8: step 4: apply the first pipe body 5 on the outer surface of the first sliding part 6 from top to bottom. During the downward movement of the first pipe body 5, the lower end of the first pipe body 5 abuts against the flange edge 61, and the first sliding part 6 is driven to move downwards, so that the first slider 62 enters the gap between the first pipe body 5 and the second pipe body 4, and meanwhile the first boss 63 snaps into the first slotted hole 10. That is, the second sliding part 7 is mounted and positioned by using the second slotted hole 8, the first sliding part 6 makes use of its elastic deformability, and the clamping part 64a abuts against the upper end of the second pipe body 4, while the first slider 62 is inclined inwards, so that there will be no interference when mounting the first pipe body 5. During the downward mounting of the first pipe body 5, the first sliding part 6 achieves self-positioning, and the lower end of the first pipe body 5 abuts against the flange edge 61, and then directly moves downwards, so that the first slider 62 automatically aligns and enters the gap between the first pipe body 5 and the second pipe body 4, and the mounting process is convenient and quick.

### Embodiment 2

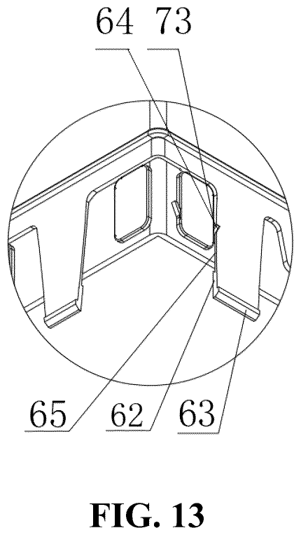

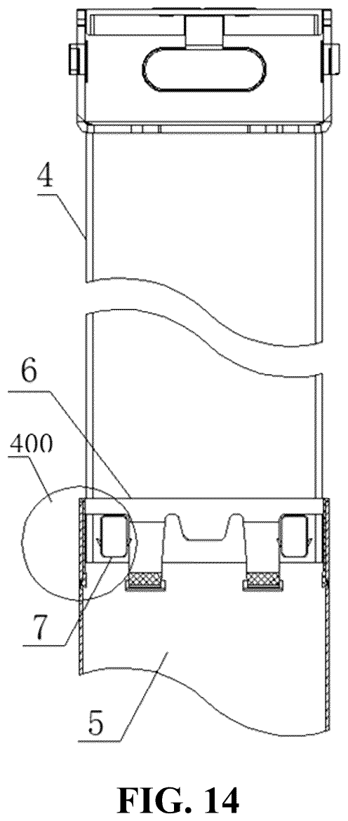

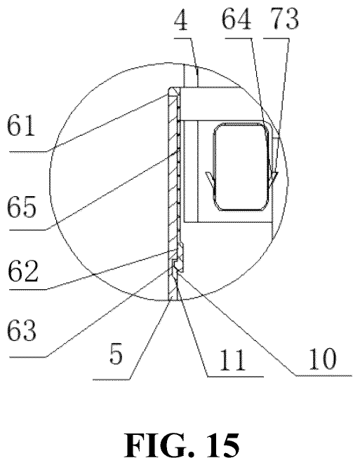

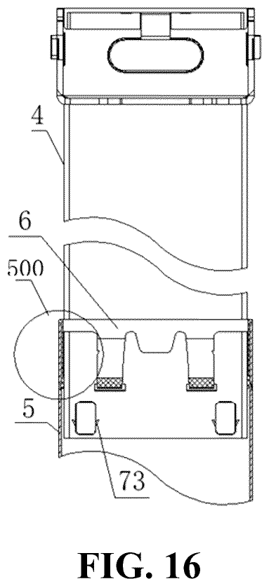

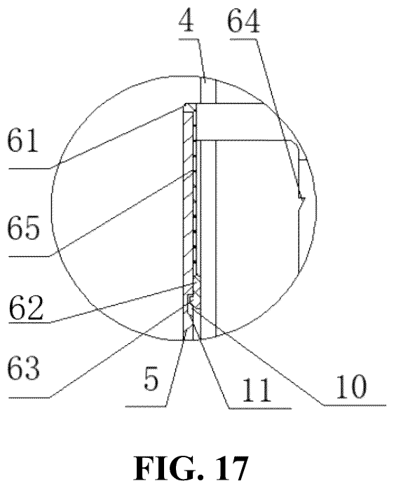

As shown in FIGS. 10 through 19, the present disclosure discloses a sliding structure, which comprises a first pipe body 5, a second pipe body 4, a second sliding part 7 and a first sliding part 6, where the second pipe body 4 is slidable disposed in the first pipe body 5. One side of the second sliding part 7 is clamped on the outer wall of the second pipe body 4, and the other side of the second sliding part 7 is slidable connected to the inner wall opposite the first pipe body 5. When the first sliding part 6 is not mounted, part of the first sliding part 6 extends beyond the end of the second pipe body 4, and the first sliding part 6 is indirectly clamped on the second pipe body 4 by the second sliding part 7. When the first sliding part 6 is mounted, the first sliding part 6 is detached from the end of the second pipe body 4, one side of the first sliding part 6 is clamped on the inner wall of the first pipe body 5, and the other side of the first sliding part 6 is slidable connected to the outer wall of the second pipe body 4.

In other words, the first pipe body 5 is slidable applied on the second pipe body 4, and the first sliding part 6 and the second sliding part 7 are arranged between the first pipe body 5 and the second pipe body 4, so that the contact-free sliding between the first pipe body 5 and the second pipe body 4 can be achieved. The first sliding part 6 and the first pipe body 5 are relatively fixed, and the second sliding part 7 and the second pipe body 4 are relatively fixed. When the first pipe body 5 and the second pipe body 4 are extended, the distance between the first sliding part 6 and the second sliding part 7 becomes shorter. When the first pipe body 5 and the second pipe body 4 contract, the distance between the first sliding part 6 and the second sliding part 7 becomes longer. The cross sections of the first pipe body 5 and the second pipe body 4 are rectangular shapes, or other shapes, such as round, square, and oval shapes.

According to the present disclosure, the pocket holes required for mounting the first sliding part 6 are reduced in quantity: which reduces the production cost, improves the service strength of the pipe wall, and avoids the deformation of the pipe wall. When the first sliding part 6 is mounted, the first sliding part 6 is indirectly clamped on the second pipe body 4 through the second sliding part 7, and part of the first sliding part 6 extends beyond the end of the second pipe body 4, so no additional positioning tool is needed to fix the first sliding part 6. At the same time, the inner space outside the end of the second pipe body 4 is used to make part of the first sliding part 6 be inclined inwards (it can be directly formed or inclined inward by external force), an outer circumference of the extending part of the first sliding part 6 is smaller than an inner circumference of the first pipe body 5, thus the first sliding part 6 can be smoothly mounted in the first pipe body 5, reducing the processing and assembly costs and improving the assembly efficiency.

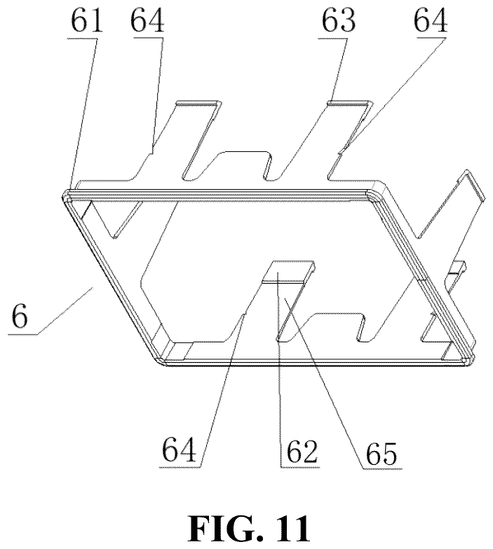

As shown in FIGS. 11 through 17, the first sliding part 6 includes a connecting part 65, a flange edge 61, and a plurality of first sliders 62. In some embodiments, the connecting part 65 is disposed between the second pipe body 4 and the first pipe body 5. The flange edge 61 is disposed at one end of the connecting part 65, and abuts against the end face of the first pipe body 5. A plurality of first sliders 62 are connected to the other end of the connecting part 65. That is, the flange edge 61 and the first slider 62 are connected by the connecting part 65, the first slider 62 is located between the second pipe body 4 and the first pipe body 5 for sliding guidance, the flange edge 61 is located at the end of the first pipe body 5, and the plane of the flange edge 61 is perpendicular to the axis of the first pipe body 5, which is convenient for the first pipe body 5 to push the flange 61, thus driving the first sliding part 6 to move.

As shown in FIGS. 10 and 12 through 16, one end of the outer wall of the second pipe body 4 is provided with a plurality of second slotted holes 8, the second sliding part 7 contains a second boss 72 and a second sliding part 71, and the second boss 72 is clamped in the second slotted holes 8. The second slider 71 is connected to the second boss 72, and the second slider 71 is slidable connected to the first pipe body 5. By the snap-fit between the second boss 72 and the second slotted hole 8, the second sliding part 7 can be conveniently mounted on the second pipe body 4.

In some embodiments, when the first sliding part 6 is indirectly clamped on the second pipe body 4, the connecting part 65 is engaged with the second sliding part 7, and the first slider 62 extends beyond the end of the second pipe body 4. In other words, since the second sliding part 7 is clamped with the second slotted hole 8 by the second boss 72, the connecting part 65 of the first sliding part 6 is engaged with the second sliding part 7, and the first slider 62 is disposed outside the end of the second pipe body 4, so that the first slider 62 can dodge inwards when the first pipe body 5 is being mounted.

In some embodiments, the second sliding part 7 is equipped with clamping teeth 73, and the connecting part 65 is equipped with bayonets 64 matching the clamping teeth 73. When the first sliding part 6 is not mounted, the clamping teeth 73 are engaged with the bayonets 64. Alternatively, the bayonets 64 can be arranged on one side of the second slider 71, and the clamping teeth 73 can be arranged on the connecting part 65. After the positions of the bayonets 64 and the clamping teeth 73 are interchanged, the engagement during assembly can still be realized.

In some embodiments, the cross section of each bayonet 64 is an L-shaped structure, and the bayonet 64 comprises a stop wall and an escape wall, which are connected to form the L-shaped structure. The stop wall is located at the side of the bayonet 64 close to the flange edge 61, an acute angle is formed between the stop wall and the escape wall, each of the clamping teeth 73 is a rod-shaped protrusion inclined to the bayonet 64. When the first sliding part 6 is not mounted, the bottom surface of the rod-shaped protrusion abuts against the stop wall, and the side surface of the rod-shaped protrusion abuts against the escape wall. That is, the bayonet 64 is equipped with a stop wall and an escape wall, and each of the clamping teeth 73 is an inclined rod-shaped protrusion. When the bottom surface of the rod-shaped protrusion abuts the stop wall, it can stop the first sliding part 6 from moving along the axial direction of the second pipe body 4. When the escape wall abuts against the side surface of the rod-shaped protrusion, the two abutting surfaces are inclined planes and form an acute angle with the axial direction of the second pipe body 4. In this way, when the first sliding part 6 is away from the second sliding part 7 along the axial direction of the second pipe body 4, the clamping teeth 73 can slide out of the bayonets 64 along the escape wall or the side surface of the rod-shaped protrusion, which makes the first sliding part 6 easily be detached from the second sliding part 7.

In some embodiments, a plurality of first sliders 62 are arranged along the circumferential direction of the second pipe body 4, and a plurality of second sliders 71 are arranged along the circumferential direction of the second pipe body 4. That is, the first slider 62 and the second slider 71 are arranged around the second pipe body 4 at the same time to ensure that the gap between the second pipe body 4 and the first pipe body 5 in the circumferential direction is uniform during sliding, so that the sliding process is smoother.

According to an embodiment of the present disclosure, a sliding gap exists between the second pipe body 4 and the first pipe body 5, the thickness of the connecting part 65 is less than the sliding gap, and the thickness of the first slider 62 is more than or equal to the sliding gap. In some embodiments, interference fit can be realized between the first slider 62 and the sliding gap, and clearance fit can be realized between the connecting part 65 and the second pipe body 4. In other words, the second pipe body 4 and the first pipe body 5 are slidable connected by the first slider 62 and the second slider 71, and the thickness of the first slider 62 and that of the second slider 71 are more than or equal to the sliding gap between the second pipe body 4 and the first pipe body 5. In some embodiments, the thickness of the first slider 62 and the second slider 71 is slightly more than the sliding gap, so that interference fit can be realized between the first slider 62 and the second slider 71 with the sliding gap during sliding, thus the second pipe body 4 and the first pipe body 5 do not shake when sliding. The thickness of the connecting part 65 is less than the sliding gap, and a gap exists between the connecting part 65 and the second pipe body 4, so the connecting part 65 is thinner, and a movable space exists between the connecting part 65 and the second pipe body 4. On the one hand, this arrangement can facilitate the first sliding part 6 to be easily applied on the second pipe body 4. On the other hand, when the first sliding part 6 is mounted, the connecting part 65 can be deformed. Because of its small thickness of the connecting part 65 and the movable space between the connecting part 65 and the second pipe body 4, when the first pipe body 5 is mounted, the connecting part 65 is easily deformed inwards to dodge the first pipe body 5 during mounting, thus facilitating the first pipe body 5 to be applied on the second pipe body 4.

In some embodiments, the first slider 62 is provided with a first boss 63 on the side facing the first pipe body 5, and the end of the inner wall of the first pipe body 5 is provided with a plurality of first slotted holes 10 for accommodating the first bosses 63. In some embodiments, the side of the first slotted hole 10 far away from the flange edge 61 forms a chamfered surface 11, and the side of the first slotted hole 10 close to the flange edge 61 abuts against the first boss 63. In other words, the flange edge 61 abuts against the first pipe body 5, thus forming the first limit point, and the first boss 63 is clamped in the first slotted hole 10, thus forming the second limit point. As the first sliding part 6 passes through the upper limit point and the lower limit point in the sliding gap, the first sliding part 6 is always fixed on the end of the first pipe body 5 during sliding, thus preventing the first sliding part 6 from naturally falling off or being pulled out from the second pipe body after working for a long time.

In some embodiments, the side of the first boss 63 away from the flange 61 has a guide slope, which is used to guide the first pipe body 5 when the first sliding part 6 is not mounted. That is, when the first pipe body 5 is applied, the first boss 63 partially coincide with the first pipe body 5 in the sliding direction, and the guide slope is disposed to facilitate the end of the first pipe body 5 to be applied on the first sliding part 6 along the guide slope, thus improving the mounting convenience.

In some embodiments, when the first sliding part 6 is not mounted, the first slider 62 can be inclined to the inner space extending from the end of the second pipe body 4 by direct shaping or external force, so that a gap exists between the first boss 63 and the inner wall opposite the first pipe body 5. That is, when the first slider 62 is inclined towards the inside of the second pipe body 4, the first boss 63 is inclined to the inside of the second pipe body 4, so that a certain distance exists between the inner wall opposite the first pipe body 5 and the first boss 63 during mounting, which makes it easier for the first pipe body 5 to be applied on the first sliding part 6. For the scheme of directly shaping the first slider 62 to be inclined inwards, please refer to Embodiment 1. It is worth noting that the method of tilting the first slider 62 to the side by external force can be directly pressed manually; or the first slider 62 can be pressed inwards by using a small tool, so that the first slider 62 can keep the inward tilting/slow recovery state in a short period of time (for example, tens of seconds to minutes). This can be achieved by selecting plastic materials or structural design with slow recovery features, which will not go into details here.

According to an embodiment of the present disclosure, the first slotted hole 10 does not penetrate the inner wall of the first pipe body 5, and after the mounting, the exposed surface of the first pipe body 5 remains intact, which improves the aesthetic feeling.

According to an embodiment of the present disclosure, the first sliding part 6 has a ring structure, or an unclosed C-shaped ring structure, or is formed by splicing two opposite half rings. The first sliding part 6 can be designed according to the actual needs, so as to improve the adaptability. It is suitable to use wear-resistant plastic to make the first sliding part 6 and the second sliding part 7, which can be directly injection molded.

According to an embodiment of the present disclosure, the side of the first slotted hole 10 far away from the flange edge 61 forms a chamfered surface 11, and the side of the first slotted hole 10 close to the flange edge 61 abuts against the first boss 63. In this way, even if the first slotted hole 10 extends widthwise to the area of the second sliding part 7, the chamfered surface 11 will not scratch the surface of the second slider 71 during assembly.

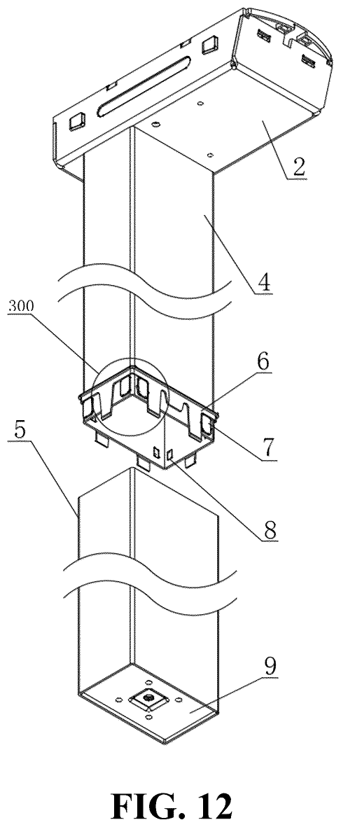

As shown in FIGS. 12 through 17, the present disclosure also provides an assembly method according to the above sliding structure, which contains the following steps: step 1, apply the first sliding part 6 on the second pipe body 4, and fix the second boss 72 on the second sliding part 7 in the second slotted hole 8: step 2: move the first sliding part 6 until the clamping teeth 73 are engaged with the bayonet 64, so that the first sliding part 6 is fixed on the second pipe body 4: step 3: apply the first pipe body 5 on the outer surface of the first sliding part 6, and the first pipe body 5 is guided by the guide slope of the first boss 63, which presses the first boss 63 and the first slider 62 to bend and deform towards the inside of the second pipe body 4, so that the first pipe body 5 can be applied on the first sliding part 6: step 4: push the first pipe body 5 to the second pipe body 4. When the end of the first pipe body 5 abuts against the flange edge 61, one side of the first sliding part 63 snaps into the inner wall of the first pipe body 10, and then the first pipe body 5 drives the first sliding part to depart from the second sliding part 7, so that the first bayonet 64 and the second clamping teeth 73 detach from each other.

### Embodiment 3

As shown in FIGS. 1 and 2, the present disclosure also provides an actuator, which comprises the sliding structure as described above: a box body 2, inside which the driving part 1 is disposed, the box body 2 being fixedly connected with one end of the sliding structure: a screw rod assembly 3, which is arranged in the sliding structure. The screw rod assembly 3 contains a hollow transmission rod 31, a screw rod 32, and a nut 33. One end of the hollow transmission rod 31 is coaxially connected to the rotating end of the driving part 1, and the other end of the hollow transmission rod 31 is fixedly connected with the nut 33. The screw rod 32 is disposed inside the hollow transmission rod 31, and the outer peripheral surface of the screw rod 32 is engaged with the nut 33 by threads. In some embodiments, the end of the screw rod 32 far away from the box body 2 is connected to the other end of the sliding structure, and the driving part 1 drives the sliding structure to do retractable motion by the screw rod assembly 3.

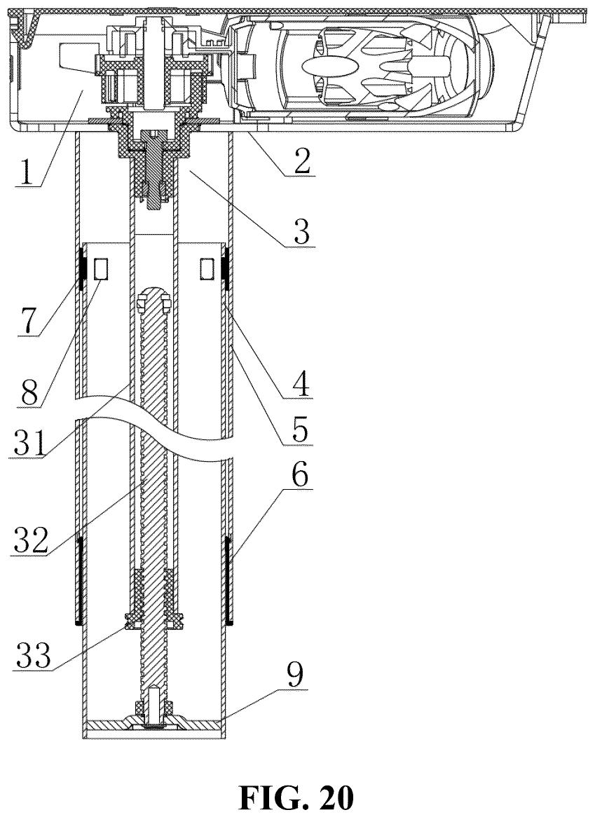

In some embodiments, as shown in FIG. 20, the end of the screw rod 32 far from the box body 2 is directly connected to the bottom plate 9, the outer peripheral surface of the bottom plate 9 is fixedly connected to the inner wall of the second pipe body 4, and the box body 2 is fixedly connected to the first pipe body 5, preferably by welding. Alternatively, as shown in FIG. 1, the end of the screw rod 32 far from the box body 2 is directly connected to the bottom plate 9, the outer peripheral surface of the bottom plate 9 is fixedly connected to the inner wall of the first pipe body 5, preferably by welding, and the box body 2 is fixedly connected to the second pipe body 4.

As a variant of Embodiment 3, the screw rod assembly 3 of the actuator shown in FIGS. 1 and 2 can be mounted upside down. That is, one end of the screw rod 32 is coaxially connected to the rotating end of the driving part 1, one end of the hollow transmission rod 31 is fixed to the base plate 9, and the nut 33 fixed on the hollow transmission rod 31 is engaged with the screw rod 32 by threads. When working, the screw rod 32 is driven to rotate, and the hollow transmission rod 31 and the nut 33 linearly expands or contracts along the axis of the screw rod 32 without rotating.

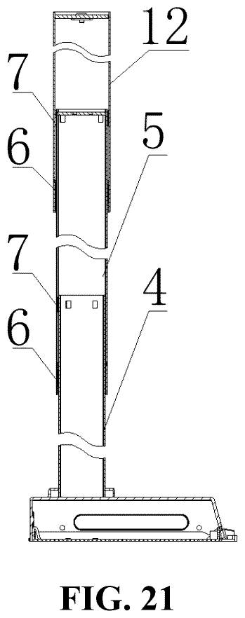

In some embodiments, as shown in FIG. 21, the sliding structure further contains a third pipe body 12 which is slidable applied outside the first pipe body 5, and the structure between the third pipe body 12 and the first pipe body 5 is the same as that between the first pipe body 5 and the second pipe body 4.

That is, the driving part 1 provides rotational power, and the screw rod assembly 3 converts the rotational power into linear retractable power. The sliding structure of this application can be that the first pipe body 5 is connected with the box body 2, or the second pipe body 4 is connected with the box body 2. The first pipe body 5 and the second pipe body 4 are driven by the screw rod assembly 3 to generate relative sliding. At the same time, the sliding structure is not limited to the sliding between the two pipes, but also can include the third pipe body 12 or more pipe bodies to form a multi-stage sliding structure, thus increasing the application range. The actuator can be widely used in lifting furniture, providing stable and reliable lifting function.

In the description of this specification, terms “an embodiment,” “some embodiments,” “illustrative embodiments,” “examples,” “specific examples,” or “some examples” mean that the specific features, structures, materials or characteristics described in connection with the embodiments or examples are included in at least one embodiment or example of the present disclosure. In this specification, the illustrative expressions of the above terms do not necessarily refer to the same embodiment or example. Furthermore, the specific features, structures, materials or characteristics described may be combined in any one or more embodiments or examples in a suitable manner.

Although the embodiments of the present disclosure have been shown and described, those skilled in the art can understand that many changes, modifications, substitutions and variations can be made to these embodiments without departing from the principles and purposes of the present disclosure, and the scope of the present disclosure is defined by the claims and their equivalents.

1-25. (canceled)

26. A sliding structure, comprising:
a first pipe body;
a second pipe body;
a first sliding part; and
a second sliding part,
wherein:
the second pipe body is slidable provided inside the first pipe body;
a first side of the second sliding part is clamped on an outer wall of the second pipe body and a second side of the second sliding part is slidable connected to an inner wall of the first pipe body;
before mounting the first pipe body to the second pipe body, the first sliding part is clamped on the second pipe body and a part of the first sliding part extends beyond an end of the second pipe body, the first sliding part being clamped on the second pipe body directly or indirectly through the second sliding part; and
when mounting the first pipe body to the second pipe body, the first sliding part is detached from the end of the second pipe body, a first side of the first sliding part is clamped on the inner wall of the first pipe body, and a second side of the first sliding part is slidable connected to the outer wall of the second pipe body.

27. The sliding structure according to claim 26, wherein the first sliding part comprises:
a flange edge;
a plurality of connecting parts; and
a plurality of first sliders,
wherein:
each connecting part of the plurality of connecting parts is arranged between the flange edge and a corresponding first slider of the plurality of first sliders; and
when mounting the first pipe body to the second pipe body, the flange edge abuts against an end face of the first pipe body, and the plurality of connecting parts and the plurality of first sliders are provided between the first pipe body and the second pipe body.

28. The sliding structure according to claim 26, wherein:
a plurality of second slotted holes are arranged at an end of the outer wall of the second pipe body;
the second sliding part comprises a second boss and a second slider connected to the second boss;
the second boss is clamped inside a second slotted hole of the plurality of the second slotted holes; and
the second slider is slidable connected to the first pipe body when mounting the first pipe body to the second pipe body.

29. The sliding structure according to claim 27, wherein, before mounting the first pipe body to the second pipe body, the first sliding part is clamped on the second pipe body directly, and the plurality of first sliders are inclined towards an inner side of the second pipe body and extend beyond the end of the second pipe body, so that the plurality of first sliders are clamped on the end of the second pipe body.

30. The sliding structure according to claim 29, wherein:
the first sliding part comprises a plurality of clamping parts, each clamping part of the plurality of clamping parts is provided between a corresponding first slider of the plurality of first sliders and a corresponding connecting part of the plurality of the connecting parts;
the plurality of clamping parts face the second pipe body; and
before mounting the first pipe body to the second pipe body, the plurality of clamping parts are clamped on and abuts against the end of the second pipe body.

31. The sliding structure according to claim 30, wherein each clamping part comprises a transition surface, a first end of the transition surface being connected to the corresponding first slider and a second end of the transition surface being connected to the corresponding connecting part.

32. The sliding structure according to claim 27, wherein, before mounting the first pipe body to the second pipe body, the first sliding part is clamped on the second pipe body indirectly through the second sliding part, the first sliding part is engaged with the second sliding part, and the plurality of first sliders extend beyond the end of the second pipe body.

33. The sliding structure according to claim 32, wherein:
the second sliding part comprises a clamping tooth;
the first sliding part comprises a bayonet matching the clamping tooth; and
before mounting the first pipe body to the second pipe body, the clamping tooth is engaged with the bayonet.

34. The sliding structure according to claim 33, wherein:
the bayonet comprises a stop wall at a side of the bayonet close to the flange edge and an escape wall connected to the stop wall, an acute angle being formed between the stop wall and the escape wall;
the clamping tooth comprises a rod-shaped protrusion inclined towards the bayonet; and
before mounting the first pipe body to the second pipe body, a bottom surface of the rod-shaped protrusion abuts against the stop wall and a side of the rod-shaped protrusion abuts against the escape wall.

35. The sliding structure according to claim 27, wherein:
a sliding gap exists between the first pipe body and the second pipe body;
a thickness of each connecting part of the plurality of connecting parts is less than a width of the sliding gap; and
a thickness of each first slider of the plurality of first sliders is more than or equal to the width of the sliding gap.

36. The sliding structure according to claim 27, wherein:
a sliding gap exists between the first pipe body and the second pipe body;
interference fit is realized between each first slider of the plurality of first sliders and the sliding gap; and
clearance fit is realized between each connecting part of the plurality of connecting parts and the second pipe body.

37. The sliding structure according to claim 27, wherein:
the first sliding part comprises a plurality of first bosses;
each first slider of the plurality of first sliders is provided with a corresponding first boss of the plurality of first bosses on a side facing the first pipe body;
a plurality of first slotted holes are provided at an end of the inner wall of the first pipe body; and
each first slotted hole of the plurality of first slotted holes accommodates a corresponding first boss of the plurality of first bosses.

38. The sliding structure according to claim 37, wherein, before mounting the first pipe body to the second pipe body, a gap exists between each first boss and the inner wall and the first pipe body.

39. The sliding structure according to claim 37, wherein the plurality of first slotted holes do not penetrate the inner wall of the first pipe body.

40. The sliding structure according to claim 37, wherein:
a first side of each first slotted hole far away from the flange edge forms a chamfered surface; and
a second side of each first slotted hole close to the flange edge abuts against the corresponding first boss.

41. The sliding structure according to claim 37, wherein:
a first side of each first boss of the plurality of first bosses far away from the flange edge forms a guide slope; and
before mounting the first pipe body to the second pipe body, the guide slope is configured for guiding the first pipe body.

42. The sliding structure according to claim 27, wherein the plurality of first sliders are arranged along a circumferential direction of the second pipe body.

43. The sliding structure according to claim 28, further comprising a plurality of second sliding parts, wherein second sliders of the plurality of second sliding parts are arranged along a circumferential direction of the second pipe body.

44. The sliding structure according to claim 26, wherein the first sliding part is an annular structure, an unclosed C-shaped annular structure, or formed by splicing two opposite half rings.

45. A mounting method of a sliding structure comprising a first pipe body, a second pipe body, a first sliding part, and a second sliding part, wherein the mounting method comprises:
vertically placing the second pipe body on an operating platform;
applying the first sliding part on the second pipe body from top to bottom until the first sliding part is clamped on an upper end of the second pipe body, wherein a part of an inner side of the first sliding part abuts against the upper end of the second pipe body and a plurality of first sliders of the first sliding part are inclined towards an inside of the second pipe body, the plurality of first sliders being connected to a flange edge of the first sliding part;
mounting the second sliding part on the second pipe body; and
applying the first pipe body on an outer surface of the first sliding part from top to bottom, wherein, during a downward movement of the first pipe body, a lower end of the first pipe body abuts against the flange edge of the first sliding part and drives the first sliding part to move downward, so that the plurality of first sliders are positioned between the first pipe body and the second pipe body.

46. A mounting method of a sliding structure comprising a first pipe body, a second pipe body, a first sliding part, and a second sliding part, wherein the mounting method comprises:
applying the first sliding part on the second pipe body and fixing the second sliding part on the second pipe body;
moving the first sliding part until it is engaged with the second sliding part, so that the first sliding part is fixed on the second pipe body;
applying the first pipe body on an outer surface of the first sliding part, wherein the first pipe body presses the first sliding part to bend and deform towards the second pipe body, so that the first pipe body can be applied on the first sliding part; and
pushing the first pipe body to the second pipe body, wherein, when an end of the first pipe body abuts against a flange edge of the first sliding part, a side of the first sliding part is clamped on an inner wall of the first pipe body, and, when the first pipe body further pushes the flange edge, the first pipe body drives the first sliding part to depart from the second sliding part.

47. An actuator, comprising:
a sliding structure, comprising a first pipe body, a second pipe body, a first sliding part, and a second sliding part;
a driving part;
a box body; and
a screw rod assembly, comprising a hollow transmission rod, a screw rod and a nut;
wherein:
the second pipe body is slidable provided inside the first pipe body;
a first side of the second sliding part is clamped on an outer wall of the second pipe body and a second side of the second sliding part is slidable connected to an inner wall of the first pipe body;
before mounting the first pipe body to the second pipe body, the first sliding part is clamped on the second pipe body and a part of the first sliding part extends beyond an end of the second pipe body, the first sliding part being clamped on the second pipe body directly or indirectly through the second sliding part;
when mounting the first pipe body to the second pipe body, the first sliding part is detached from the end of the second pipe body, a first side of the first sliding part is clamped on the inner wall of the first pipe body, and a second side of the first sliding part is slidable connected to the outer wall of the second pipe body;
the driving part is provided inside the box body;
the box body is fixedly connected to a first end of the sliding structure;
the screw rod assembly is provided inside the sliding structure;
a first end of the hollow transmission rod is connected to a rotating end of the driving part and a second end of is fixedly connected to the nut;
a screw rod is disposed inside the hollow transmission rod and an outer peripheral surface of the screw rod is engaged with the nut by threads;
an end of the screw rod far away from the box body is connected to a second end of the sliding structure; and
the driving part drives the sliding structure to perform concertina movement by the screw rod assembly.

48. The actuator according to claim 47, wherein:
the end of the screw rod far away from the box body is directly connected to a bottom plate;
an outer peripheral surface of the bottom plate is fixedly connected to an inner wall of the second pipe body; and
the box body is fixedly connected to the first pipe body.

49. The actuator according to claim 47, wherein:
the end of the screw rod far away from the box body is directly connected to a bottom plate;
an outer peripheral surface of the bottom plate is fixedly connected to the inner wall of the first pipe body; and
the box body is fixedly connected to the second pipe body.

50. The actuator according to claim 47, wherein:
the sliding structure further comprises a third pipe body slidable applied outside to first pipe body; and
a mounting structure between the third pipe body and the first pipe body is the same as a mounting structure between the first pipe body and the second pipe body.
